(19) United States
(12) Patent Application Publication
(10) Pub. No.: US 2005/0284444 A1
(43) Pub. Date: Dec. 29, 2005

(54) Asymmetrical thermodynamic cycle and engine to implement it

(76) Inventor: Victor L. Sherman, Mastic Beach, NY (US)

Correspondence Address: Victor L. Sherman, 67 Woodcut Drive, Mastic Beach, NY, 11951, US

(21) Appl. No.: 10/878,947

(22) Filed: Jun. 29, 2004

(51) Int. Cl. F02B 75/02; F01L 1/34; F02B 75/04

(52) U.S. Cl. 123/316; 123/48 A; 123/90.18

(57) ABSTRACT

A method and device for achieving complete combustion and greater efficiency throughout a broad range of power outputs in a four-stroke internal combustion engine intended for use mostly at sea level by providing a means of controlling the amount of air to be compressed in a fixed ratio to the amount of fuel to be injected together with a means of controlling of the volume to which the fuel-to-air mixture is to be compressed prior to ignition in a fixed optimum ratio to the volume of air taken in with an ability to use different octane fuels and a power stroke that is always longer than the adjusted compression stroke in order to yield greater work output at lower exhaust pressure than engines designed for equal compression and power stroke operation. This reduces fuel consumption, noise and pollution and improves total engine efficiency to 35-40%.

### TECHNICAL FIELD

The present invention relates to improvements in 4-stroke internal combustion engines (gasoline, diesel, etc.) used for transportation, generation of energy, or powering of different mechanisms.

### BACKGROUND ART

Internal combustion engines to which the present invention is related are based mostly on Otto or Diesel thermodynamic cycles, or on their variations. These engines are widely described in literature. They are inexpensive, have high power-to-weight ratios, and are relatively economical. But their efficiency is still substantially less than the thermodynamically possible theoretical limit.

One of their problems is that the length of the compression stroke is equal to the length of the power stroke. Therefore, the gases during the power stroke (which obviously have higher pressure) cannot expand enough to expend all of their energy within the cylinder. As a result, they exhaust at too high a pressure, so that their energy is not fully utilized for mechanical work. In terms of thermodynamics it means that the cycle of conventional engines is symmetrical, i.e. the volume of fuel-air mixture taken in (and then compressed) is equal to the volume to which combustion gases expand within an engine after combustion. Their unused power goes to the exhaust.

An additional adverse factor in known engines is that adjusting their power output is done by changing the amount of fuel fed to a cylinder while the amount of air taken in remains unchanged equal to the full capacity of the cylinder(s). This means that the engine works generally at a non-optimal fuel-to-air ratio. This fact additionally increases fuel consumption and aggravates environmental pollution.

Attempts to cope with these problems by controlling the movements of intake valve(s) alone (U.S. Pat. No. 6,679,207) cannot fully solve the problem because this measure only allows control of the amount of fuel fed into the cylinders at the expense of reducing the actual pre-combustion pressure and thus reducing the efficiency of the engine.

Attempts to cope with the above problem by varying the volume of the combustion chamber as per U.S. Pat. No. RE23,307 cannot be successful either. This patent allows the engine to compensate for the reduction of ambient air pressure at highly increased altitude (for instance, in aircraft) by increasing the compression ratio well beyond the values acceptable for operation at standard sea level. Thus for automobiles operating mostly at standard sea level, this invention is not applicable.

The problem of the efficiency of internal combustion engines operating mostly at standard sea level is addressed in the present invention.

### SUMMARY OF THE INVENTION

The present invention relates in general to a method and device for improving the efficiency of the internal combustion engine which work mostly at sea level and, more specifically, to a method and device for achieving a more efficient thermodynamic cycle in the internal combustion engine by providing the following:
(a) A means of controlling the amount of air to be compressed in a fixed ratio to the amount of fuel to be injected and
(b) A means of controlling of the volume to which the fuel-to-air mixture is to be compressed prior to ignition in a fixed optimum ratio to the volume of air taken in
(c) Ability to use different octane fuels
(d) Increased efficiency in four cycle piston engines due to complete combustion of fuel at the maximum pre-combustion pressure possible for the fuel used over a wide (close to full) power range. Thus under this new, more efficient thermodynamic cycle, power output is adjusted by jointly adjusting the amount of fuel and the volume of the air to be compressed within the engine cylinder(s);
(e) Additional increase in engine efficiency due to the expansion of combustion gases during every power stroke within the engine cylinder(s) to a volume greater than the volume of the air initially compressed (asymmetrical cycle)thus extracting more work from the action of the piston in the inventive engine than from that of prior art.

The above control devices can be either mechanical cams, or electronically/computer controlled mechanisms to control both the intake and/or exhaust valve(s); and the effective volume of the combustion chamber(s).

The devices in group (a) allow part of the air taken in during the intake stroke to escape during the compression stroke through the still open intake/exhaust valve(s) until the amount of air left in the cylinder is exactly enough for the consumption of all of the fuel to be injected to the cylinder at the particular throttle setting. After reaching this point, the valve(s) close, compression begins and the fuel is actually injected into the cylinder. But used only by themselves, these devices (in group a) reduce the compression ratio at which ignition is being initiated, thus reducing the efficiency of the engine.

The devices of group (b) control the compression ratio at the peak of the compression stroke (the ratio is fixed per this invention depending on the design of the engine and octane of the fuel). For this purpose, a conditioning piston is provided to adjust the effective volume of the combustion chamber to the amount of air being compressed. This conditioning piston is driven either via mechanical linkages, or is electronically controlled. Its movements, however, are the part of adjustments and are not part of the cycle. But by themselves, if not combined with adjustment of the beginning of compression, the movements of the conditioning piston change the compression ratio, either reducing the efficiency of the engine, or causing detonation of the fuel.

The devices of the group (c) tune the combustion chamber to the particular octane of the fuel by setting the position of conditioning piston. Only the unique combination of variable compression stroke and variable effective volume of combustion chamber(s) both controlled in dependence of the amount of fuel fed to keep the compression ratio permanent, conditions the engine for extracting more power from the same amount of fuel used (or using less fuel for the same power delivered). As a result, fuel consumption is reduced.

Because of more complete combustion, the level of pollution is reduced too. In addition, since exhaust gases in the inventive engine leave the cylinders at substantially lower pressure and temperature, the losses of power in the process of muffling, are also reduced.

With all of these features, in the range of 15 to 300 Hp, the efficiency of the inventive engine can be as much as 35 to 45% which is substantially better than the efficiency of regular internal combustion engines (usually under 25%).

The novel features of the present invention are set forth in particular in the appended claims. The invention itself, however, will be best understood from the description of the preferred embodiment which is accompanied by the following drawings.

### BRIEF DESCRIPTION OF THE DRAWINGS

FIG. 1 depicts the pressure-volume diagram of the inventive thermodynamic cycle shown in three different levels of power.

FIG. 2 shows a schematic diagram of the engine which implements the inventive cycle.

FIG. 3 shows an isometric diagram of the inventive engine.

### DESCRIPTION OF THE PREFERRED EMBODIMENTS

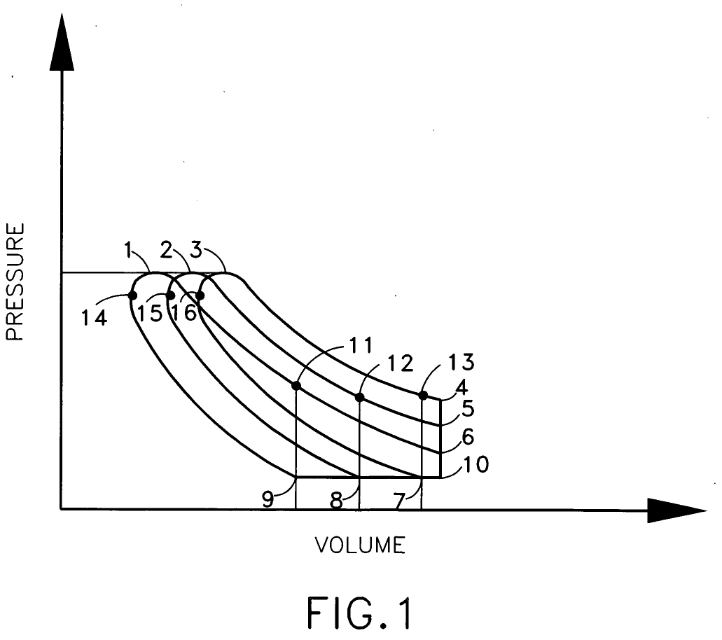

The inventive method of achieving complete combustion of fuel and oxygen within engine's cylinders is explained in the pressure-volume diagram in FIG. 1. The diagram shows three pressure-volume function curves at three different throttle settings. The low throttle process curve is described by the line beginning at the idle portion of the compression stroke 10, progressing to the beginning of the active portion of the compression stroke 9, to the peak of the compression stroke and the point of minimum volume of the mixture prior to ignition 14, to the point of, maximum pressure of the power stroke 1, through the point on the power stroke at which the combustion gases have expanded to the volume of the air originally compressed 11, to the end of the power stroke 6. The intermediate throttle process curve is described by the line beginning at the idle portion of the compression stroke 10, progressing to the beginning of the active portion of the compression stroke 8, to the peak of the compression stroke and the point of minimum volume of the mixture prior to ignition 15, to the point of, maximum pressure of the power stroke 2, through the point on the power stroke at which the combustion gases have expanded to the volume of the air originally compressed 12, to the end of the power stroke 5. The maximum throttle process curve is described by the line beginning at the idle portion of the compression stroke 10, progressing to the beginning of the active portion of the compression stroke 7, to the peak of the compression stroke and the point of minimum volume of the mixture prior to ignition 16, to the point of maximum pressure of the power stroke 3, through the point on the power stroke at which the combustion gases have expanded to the volume of the air originally compressed 13, to the end of the power stroke 4.

In contrast to the method used in standard engines, the inventive method adjusts the volume of air to be compressed in accordance with the current amount of the fuel fed (that is, with the current throttle setting) to achieve full combustion of both the fuel and the oxygen of the air compressed to the optimum controllable compression. This is done by adjusting both the beginning points of the compression 7, 8, and 9 in FIG. 1 and the final volumes of the mixture 14, 15 and 16 when the same optimum compression is reached. As the result, within the wide range of the throttle settings (except for pre-idling and idling modes), all of the fuel as well as all of the oxygen of the compressed air are combusted at the optimum compression.

At all throttle settings, the continuation of the stroke due to the expansion of combustion gases beyond the positions at which the original volume of the air was compressed 11, 12 and 13 in FIG. 1 provides extra work [represented by the three areas within the low, medium and maximum throttle pressure-volume function curves in FIG. 1 which are each defined by the following three sets of four reference numbers 10, 9,11,6; 10, 8, 12, 5 and 10, 7, 13, 4 respectively]. This feature is specific to the present invention which thus increases the efficiency of the inventive engine compared to that of conventional engines.

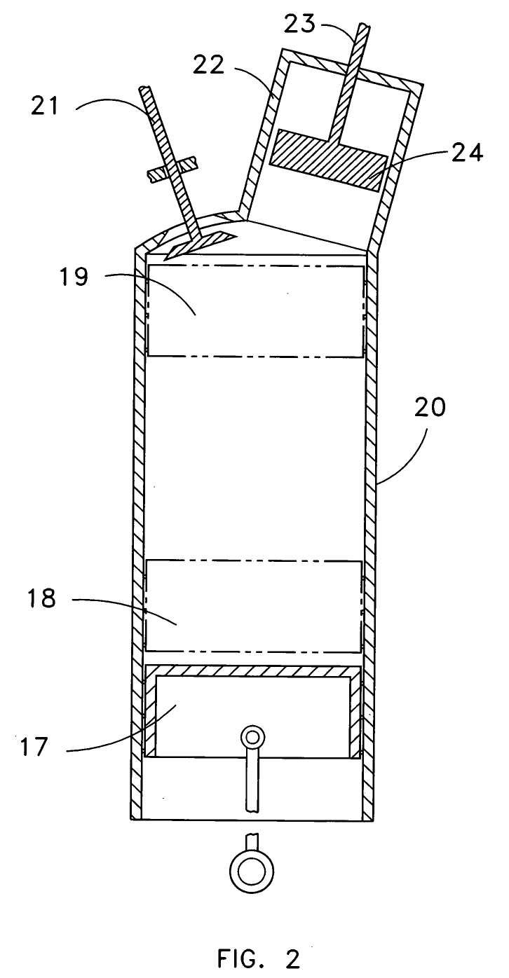

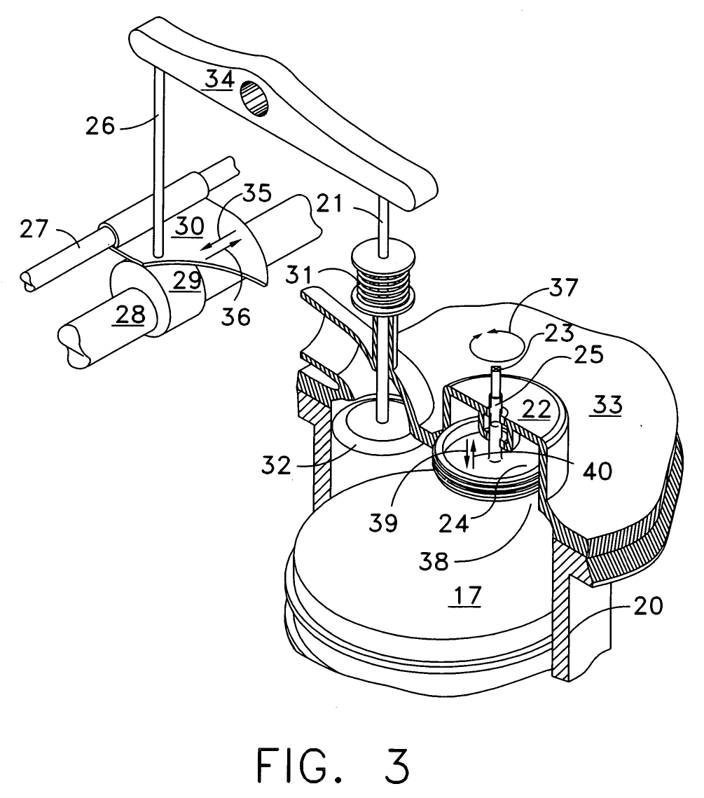

The above method is implemented in the engine schematically shown in FIG. 2. While at the first (intake) stroke, the piston 17 of the cylinder 20 moves down taking air into the cylinder up to its full displacement, at the beginning of the second (compression) stroke, the intake valve 21 remains opened, thus returning air from the cylinder back to the atmosphere. Only when piston 17 reaches position 18 (determined by the throttle setting), the intake valve 21 closes, and the compression of the air begins and continues to the end of the compression stroke (piston position 19). But for establishing and maintaining the optimal combustion conditions at any throttle settings, the pre-combustion compression ratio must be maintained regardless of the point of the beginning of compression when the valve 21 closes. This is done with the conditioning piston 24. This piston can be positioned in many different ways known in the art: either by using computer-controlled electromagnetic devices or mechanical linkages. In the implementation shown in FIG. 3, the operation of the intake valve 32 is done by mechanical linkage, while the position of the conditioning piston 24 is controlled electro-mechanically.

Here, the lifting of pushrod 26 is timed by both the main cam 29 and the auxiliary cam 30 which is mounted on an axle 27. The main cam 29 has a profile typical of conventional engines. The auxiliary cam 30, however, has the shape of a wedge. It does not rotate but can be moved in either of the directions indicated by arrows 35 and 36. Advancement of cam 30 in the direction indicated by arrow 35 increases the duration of the intake valve in the open position while movement of cam 30 in the opposite direction indicated by arrow 36 results in a corresponding decrease in the duration of the intake valve 32 in the open position.

To make the engine work at full throttle and, therefore, with maximum amounts of both fuel injected and air compressed, cam 30 is moved in the direction indicated by arrow 36 (as shown in the FIG. 3) where the width of its surface contacting cam 29 is minimal. But when the amount of fuel injected is reduced, cam 30 is moved in the direction indicated by arrow 35 where the width of its surface contacting cam 29 is maximum. The greater the displacement of the cam 30 in the direction indicated by arrow 35 the less fuel is injected, the greater its width contacting the cam 29 and therefore the longer the time valve 32 is open letting more of the air to escape before compression begins (the lessor the fuel, the lessor the air).

In order to keep the compression ratio constant and optimal, the above control of the amounts of air and fuel taken in is combined with the control of the effective volume of the combustion chamber 38. Here, the conditioning piston 24 within the auxiliary cylinder 22 controls the effective volume of the combustion chamber 38. To this end, the screw 25 moves the conditioning piston 24 up and down as shown by arrows 39 and 40. An electro-mechanical connection between the screw 25 and the gas pedal turns the screw 25 to lift the piston 24 in accordance with the depression of the gas pedal. The advantage of an electro-mechanical (or computerized) connection over the use of pure mechanical devices is the capability of switching from fuel of one octane to another without loosing efficiency. Here, optimal conditions are kept by controlling circuitry that adjusts the compression ratio.

Upon injection of the fuel at the second stroke and subsequent ignition, combustion gases expand during the third (power) stroke producing useful shaft work similarly to the power stroke of conventional engines. The difference here is that the inventive engine works, in all the ranges of power output at optimum air-to-fuel ratio and at increased combustion gas expansion. Since the initial pressure of gases is greater than in conventional engines, while the pre-exhaust pressure is less than in the conventional engines, the power developed by the inventive engine is greater than the power developed by the conventional engine at the same fuel consumption (or, fuel consumption is less at the same power output).

The fourth stroke differs from the same stroke in conventional engines by the fact that because of greater expansion during the third (power) stroke, the pressure of exhausting gases is less than in conventional engines. As a result, the inventive engine waists less energy muffling exhaust noise to the same decibel level.

This invention is not limited to the details shown since various modifications and structural changes are possible without departing from the spirit of the present invention. What is desired to be protected is set forth in particular in the appended claims.

1. Method of achieving complete combustion and greater efficiency throughout a broad range of power outputs in a four-stroke internal combustion engine intended for use mostly at sea level comprising the steps of:
a) adjusting the volume of air being compressed during the compression stroke in direct proportion to the amount of fuel injected by adjusting the position within the cylinder at which the actual compression of the air begins by forming a means of adjusting the duration of the open position of the intake valve as well as forming a means of its proportionally controllable connection to the throttle in order to allow some of the air taken in during the intake stroke to escape until the volume of air remaining reaches the required amount after which the intake valve closes, the ratio of said fuel to said volume of air to be determined by those practiced in the art giving due consideration to the design and application of said engine, said application being limited to engines for use mostly at sea level.
b) adjusting the compressed fuel/air mixture in the combustion chamber to an optimum constant ratio by forming a means of adjusting the volume of the combustion chamber, said volume adjustment means to be controlled by the throttle by forming a proportionally controllable means to connect it to the throttle and therefore to be in direct dependence upon the amount of fuel injected, the compression ratio to be determined by those practiced in the art giving due consideration to maximum safe power output possible for the octane of the fuel to be used as well as whatever other engine design operating and application considerations as may be relevant.
c) Forming a cylinder of such a length that the longest adjusted compression stroke is shorter than the power stroke that follows in order to gain work output at lower final exhaust pressure over conventional engines, in which the compression and power strokes are equal.

2. method of achieving complete combustion and greater efficiency throughout a broad range of power outputs in a four-stroke internal combustion engine intended for use mostly at sea level as defined in claim 1 wherein step
a) the means of adjusting the duration of the open position of the intake valve is a curved wedge shaped timing cam that is attached along its length so that may freely rotate about and at a fixed point along an actuating rod as one of a plurality of similar cams in numbers equal to the number of cylinders, the radius of curvature of the wedge shaped cam being the maximum distance to the surface of the conventional cam from its center of rotation, the inventive cam being disposed between a conventional timing cam and a pushrod for actuating the intake valve, the curved surface of the inventive cam being in contact with the rotatable surface of the conventional cam to cooperatively control the effective timing of the valve, the duration of the timing being proportional to the position of contact between the wedged surface of the inventive cam along its length and the surface of the conventional cam, the position of said contact being proportionally controlled by the axial movement of said actuating rod of the inventive cam by forming mechanical means of linkage to the throttle so that the surface of the inventive cam can move perpendicular to and over the rotatable surface of the conventional cam from the small end of the wedge to the large end thereby varying the timing from the shortest time at the small end of the wedge at maximum throttle to the longest time at the large end of the wedge at minimum throttle, and step
b) the means of adjusting the volume of the combustion chamber is a auxiliary piston disposed within the top of the cylinder head to be proportionally controllable by forming a mechanical linkage to the throttle.

3. method of achieving complete combustion and greater efficiency throughout a broad range of power outputs in a four-stroke internal combustion engine intended for use mostly at sea level as defined in claim 2 wherein the means of control in step a) is electro-mechanical linkage to the throttle.

4. method of achieving complete combustion and greater efficiency throughout a broad range of power outputs in a four-stroke internal combustion engine intended for use mostly at sea level as defined in claim 2 wherein the means of control in step b) is through electro-mechanical linkage to the throttle.

5. method of achieving complete combustion and greater efficiency throughout a broad range of power outputs in a four-stroke internal combustion engine intended for use mostly at sea level as defined in claim 3 wherein the means of control in step b) is through electro-mechanical linkage to the throttle.

6. device for achieving complete combustion and greater efficiency throughout a broad range of power outputs in a four-stroke internal combustion engine intended for use mostly at sea level comprising:
a) a means of varying the duration of the open position of the intake valve to adjust the timing of the beginning of the compression stroke so that the volume of air compressed may be varied to achieve a fixed optimum fuel/air mixture ratio.
b) a throttle controlled means of proportionally controlling the variation of the timing of said valve.
c) a means of adjusting the volume of the combustion chamber to achieve fixed optimum fuel/air compression ratio under a broad range of power output conditions.
d) a throttle controlled means of directly controlling the adjustment of the volume of the combustion chamber.
e) a cylinder of length such that the power stroke is always longer than the adjusted compression stroke in order to yield greater work output at lower exhaust pressure than in conventional engines.

7. device for achieving complete combustion and greater efficiency throughout a broad range of power outputs in a four-stroke internal combustion engine intended for use mostly at sea level as defined in claim 6 wherein
a) the means of varying the duration of the open position of the intake valve is a curved wedge shaped timing cam that is freely and rotatably attached to an actuating rod in a plurality equal to the number of cylinders, the radius of curvature of the wedge shaped cam being the radius of the turning surface of the conventional cam with respect to the axis of the camshaft, the inventive cam being disposed between a conventional timing cam and a pushrod for actuating the intake valve, the curved surface of the inventive cam being in contact with the rotating surface of the conventional cam to cooperatively control the effective timing of the valve, the timing being proportional to the position of contact between the wedged surface of the inventive cam and the surface of the conventional cam, the position of said contact being proportionally controlled by the movement of said actuating rod of the inventive cam axially by means of mechanical linkage to the throttle so that the surface of the inventive cam moves perpendicular to and over the rotating surface of the conventional cam from the small end of the wedge to the large end thereby varying the timing from the shortest time at the small end of the wedge at maximum throttle to the longest time at the large end of the wedge at minimum throttle.
b) the throttle controlled means of proportionally controlling the variation of the timing of said valve is mechanical.
c) the means of adjusting the volume of the combustion chamber is a auxiliary piston disposed within the top of the cylinder head
d) the throttle controlled means of directly controlling the adjustment of the volume of the combustion chamber is mechanical.

8. device for achieving complete combustion and greater efficiency throughout a broad range of power outputs in a four-stroke internal combustion engine intended for use mostly at sea level as defined in claim 7 wherein part
b) the throttle controlled means of proportionally controlling the variation of the timing of said valve is electro-mechanical.

9. device for achieving complete combustion and greater efficiency throughout a broad range of power outputs in a four-stroke internal combustion engine intended for use mostly at sea level as defined in claim 7 wherein part
c) the throttle controlled means of directly controlling the adjustment of the volume of the combustion chamber is electro-mechanical.

10. device for achieving complete combustion and greater efficiency throughout a broad range of power outputs in a four-stroke internal combustion engine intended for use mostly at sea level as defined in claim 8 wherein part
d) the throttle controlled means of directly controlling the adjustment of the volume of the combustion chamber is electro-mechanical.
